(19) United States
(12) Patent Application Publication
(10) Pub. No.: US 2018/0275279 A1
(43) Pub. Date: Sep. 27, 2018

(54) ENVIRONMENT MONITORING SYSTEM AND IMAGING APPARATUS

(71) Applicant: PANASONIC INTELLECTUAL PROPERTY MANAGEMENT CO., LTD., Osaka (JP)

(72) Inventors: Hiroshi IWAI, Osaka (JP); Osamu SHIBATA, Kanagawa (JP); Tomohiro HONDA, Shiga (JP); Tomohito NAGATA, Kyoto (JP)

(73) Assignee: PANASONIC INTELLECTUAL PROPERTY MANAGEMENT CO., LTD., Osaka (JP)

(21) Appl. No.: 15/935,544

(22) Filed: Mar. 26, 2018

(30) Foreign Application Priority Data
Mar. 27, 2017 (JP) 2017-061614

(51) Int. Cl. G01S 17/89; G01S 17/10; G01S 17/87; G01S 17/02

(52) U.S. Cl. CPC G01S 17/89; G01S 17/026; G01S 17/87; G01S 17/10

(57) ABSTRACT

An environment monitoring system being mountable on a vehicle and including: a light source that emits invisible light; a plurality of first optical/electrical converters that output a signal indicating an amount of incident light, upon reception of invisible light emitted from the light source and reflected off a target in a first visual field that is a part of visual field in surroundings of the vehicle; a plurality of second optical/electrical converters that constitute a optical/electrical converter array together with the plurality of first optical/electrical converters and output a signal indicating an amount of incident light, upon reception of visual light from a second visual field containing the first visual field; and a control device that derives a distance to the target in accordance with output signals from the plurality of first optical/electrical converters. The light source emits invisible light toward the first visual field.

### CROSS REFERENCE TO RELATED APPLICATIONS

The disclosure of Japanese Patent Application No. 2017-061614 filed on Mar. 27, 2017 including the specification, drawings and abstract is incorporated herein by reference in its entirety.

### TECHNICAL FIELD

The present disclosure relates to an environment monitoring system that can derive the distance to a target around a vehicle, and an imaging apparatus used therefor.

### BACKGROUND ART

Conventionally, an environment monitoring system has been known which displays a visible image obtained by shooting surroundings of a vehicle or displays the visible image with a marking, which represents a target detected from the visible image by processing such as pattern matching, on the visible image.

However, the problem arises that pattern matching for the visible image involves errors in detection of the target. For example, traffic signs (e.g., crosswalks), trees, and the like in the visible image are detected as pedestrians by error.

To solve the aforementioned problem, the environment monitoring system emits invisible light (infrared light or near-infrared light) from a light source, receives the returning light reflected off a nearby target through a distance image sensor, and determines the distance to the target by the time of flight method.

### CITATION LIST

### Patent Literature

PTL 1
Japanese Patent Application Laid-Open No. 2007-22176

### SUMMARY OF INVENTION

### Technical Problem

However, since the output from the light source is regulated by law and the like, trade-off between the measurable distance and the angle of view (visual field) is established in the distance image sensor. For this reason, a conventional environment monitoring system has the problem that it barely achieves a sufficient measurable distance.

An object of the present disclosure is to provide an environment monitoring system that achieves a long measurable distance through the time of flight method with a low-output light source, and an imaging apparatus used therefor.

### Solution to Problem

One aspect of the present disclosure is an environment monitoring system mountable on a vehicle, including: a light source that emits invisible light; a plurality of first optical/electrical converters that output a signal upon reception of invisible light emitted from the light source and reflected off a target in a first visual field that is a part of visual field in surroundings of the vehicle, the signal indicating an amount of incident light; a plurality of second optical/electrical converters that constitute an optical/electrical converter array together with the plurality of first optical/electrical converters and output a signal upon reception of visual light from a second visual field containing the first visual field, the signal indicating an amount of incident light; and a control apparatus that derives, by the time of flight method, a distance to the target in accordance with output signals from the plurality of first optical/electrical converters. The light source emits invisible light toward the first visual field.

Another aspect of the present disclosure is an imaging apparatus mountable on a vehicle, including: a light source that emits invisible light; a plurality of first optical/electrical converters that output a signal upon reception of invisible light emitted from the light source and reflected off a target in a first visual field that is a part of visual field in surroundings of the vehicle, the signal indicating an amount of incident light; and a plurality of second optical/electrical converters that constitute an optical/electrical converter array together with the plurality of first optical/electrical converters and output a signal upon reception of visual light from a second visual field containing the first visual field, the signal indicating an amount of incident light. The light source emits invisible light toward the first visual field.

### Advantageous Effects of Invention

According to the aforementioned aspects, provided are an environment monitoring system that achieves a long measurable distance only for the first visual field even with a low-output light source, and an imaging apparatus used therefor.

### BRIEF DESCRIPTION OF DRAWINGS

FIG. 1 is a diagram illustrating a vertical visual field of an environment monitoring system of the present disclosure;

FIG. 2 is a diagram illustrating a horizontal visual field of the environment monitoring system of the present disclosure;

FIG. 3 is a diagram illustrating the configuration of the environment monitoring system in FIG. 1 and the like and an imaging apparatus used therefor,

FIG. 4 is a schematic view illustrating the arrangement of optical/electrical converters (hereinafter abbreviated as OECs) in the image sensor in FIG. 3;

FIG. 5 is a schematic view for describing a vertical angle of view of the second visual field in FIG. 1;

FIG. 6 is a schematic view illustrating a relationship between each visual field in FIG. 1 and the like and pixel arrangement;

FIG. 7 is a diagram illustrating an overview of the time of flight method;

FIG. 8A is a schematic view illustrating emitted light and returning light in the normal state;

FIG. 8B is a schematic view illustrating emitted light and returning light in the case where the returning light does not have an adequate intensity;

FIG. 9A is a schematic view illustrating arrangement of OECs of the present disclosure;

FIG. 9B is a schematic view illustrating a first alternative of OEC arrangement;

FIG. 9C is a schematic view illustrating a second alternative of OEC arrangement;

FIG. 9D is a schematic view illustrating a third alternative of OEC arrangement; and

FIG. 9E is a schematic view illustrating a fourth alternative of OEC arrangement.

### DESCRIPTION OF EMBODIMENTS

### 1 Definition

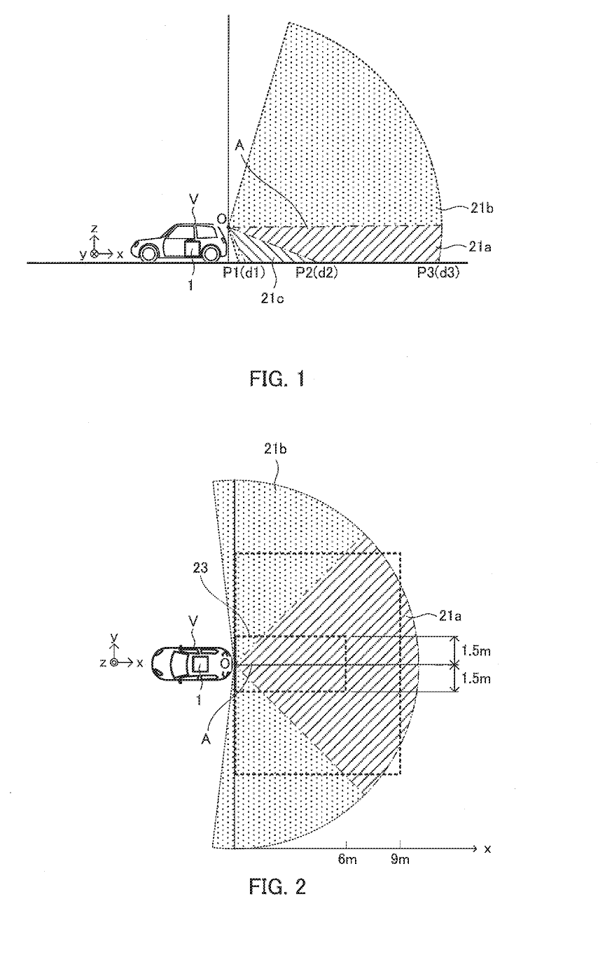

FIG. 1 and other drawings show the x-axis, the y-axis, and the z-axis intersecting each other. In the present disclosure, the x-axis indicates the direction from the front side to the rear side of vehicle V (hereinafter referred to as front-rear direction x). The y-axis indicates the direction from the left side to the right side of vehicle V (hereinafter referred to as left-right direction y). The z-axis indicates the direction from the bottom side to the top side of vehicle V (hereinafter referred to as bottom-top direction z).

In the present disclosure, for convenience, the x-y plane is a road surface, and the z-x plane is the longitudinal center plane of vehicle V. The x-axis corresponds to the longitudinal center line in a plan view from the bottom-top direction z.

Table 1 below show the definitions of the initials or abbreviations used in the following description.

TABLE 1
Definitions of Initials, etc.

| Initial, etc. | Definition |
|---|---|
| CMOS | Complementary Metal Oxide Semiconductor |
| OEC | Optical/Electrical Converter |
| IR | Infrared |
| NIR | Near Infrared |
| ROI | Region of Interest |
| ECU | Electronic Control Unit |
| TOF | Time-of-Flight |
| SNR | Signal to Noise Ratio |
| ID | Identifier |
| ADAS | Advanced Driver Assistance System |

### 2 Embodiment

Environment monitoring system 1 and imaging apparatus 11 according to one embodiment of the present disclosure will now be described with reference to accompanying drawings.

[2.1 Schematic Configuration of Environment Monitoring System 1]

As shown in FIGS. 1 and 2, environment monitoring system 1 is mounted on vehicle V. Although the description below will be made on the assumption that environment monitoring system 1 monitors the back of vehicle V, it may monitor directions other than the back of vehicle V (sides, front, or all directions).

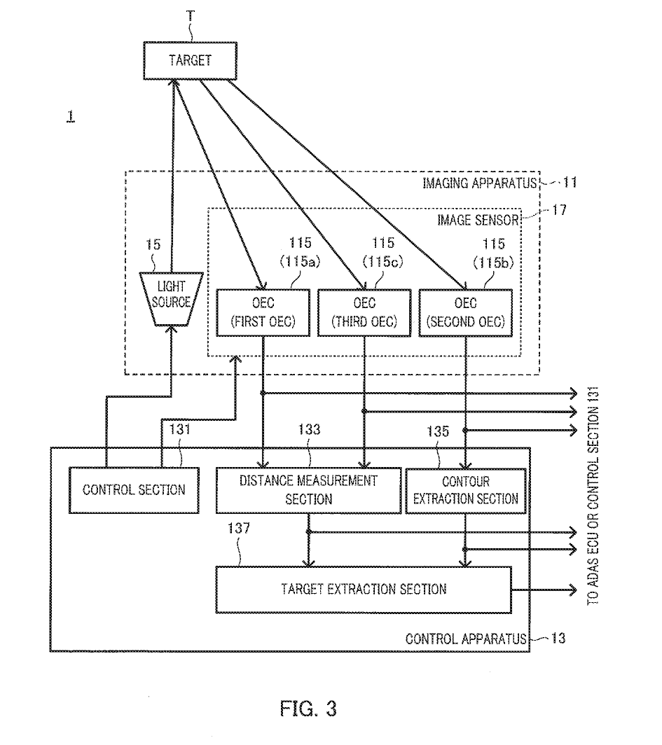

As shown in FIG. 3, environment monitoring system 1 includes imaging apparatus 11 in which light source 15 and image sensor 17 are combined, and control apparatus 13.

As shown in FIG. 1 and other drawings, imaging apparatus 11 is mounted on spot O on the back surface of vehicle V and away from the road surface.

[2.1.1 Light Source 15]

See FIGS. 1 to 3. Light source 15 is mounted in such a manner that it can emit pulsed invisible light (e.g., infrared light or near-infrared light) toward first visual field 21a (the details will be described later).

[2.1.2 Image Sensor 17]

Image sensor 17 is, for example, a CMOS image sensor, and is mounted in substantially the same spot as light source 15 in such a manner that its optical axis A extends substantially along the x-axis.

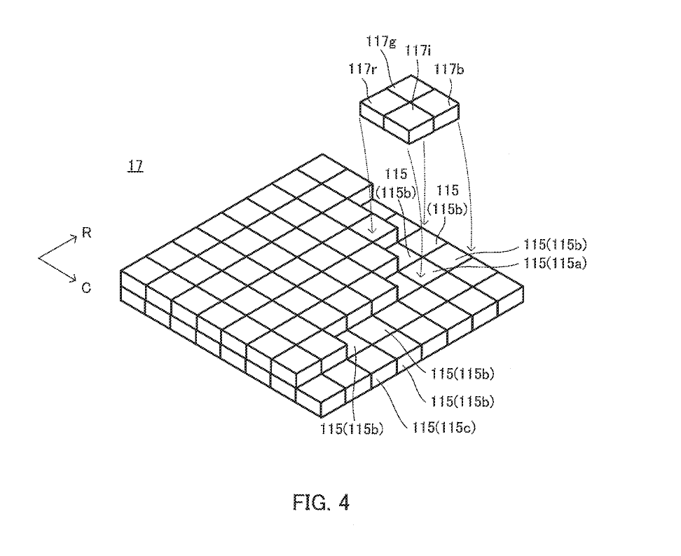

As illustrated in FIG. 4, image sensor 17 includes an optical/electrical converter array consisting of optical/electrical converters (hereinafter abbreviated as OECs) 115 in a N_{R}×N_{C} matrix. To be specific, N_{R} OECs 115 are arranged in row direction R and N_{C} OECs 115 are arranged in column direction C. N_{R} and N_{C} can be determined as appropriate.

In the present disclosure, each pixel consists of adjacent four OECs 115. Note that OECs 115 do not overlap each other between multiple adjacent pixels. Alternatively, each pixel may consist of one OEC 115.

In the present disclosure, when the invisible light is infrared light, the light-receptive surface of one OEC 115 in each pixel is covered by IR filter 117i. This light-receptive surface receives returning light (invisible light) that is light emitted from light source 15 and reflected off target T present in first visual field 21a or third visual field 21c, and OEC 115 outputs an electrical signal indicating the amount of incident light to control apparatus 13. In the present disclosure, OEC 115 receiving invisible light from first visual field 21a/third visual field 21c (the details will be described later) is referred to as first OEC 115a/third OEC 115c as shown in FIG. 3.

When the invisible light is near-infrared light, a NIR filter (not shown in the drawing) is used instead of IR filter 117i.

The light-receptive surfaces of the three other OECs 115 in each pixel are covered by red filter 117r, green filter 117g, and blue filter 117b. Accordingly, these light-receptive surfaces each receive any one of red light, green light, and blue light in visual light traveling from second visual field 21b. Each OEC 115 outputs an electrical signal indicating the amount of incident light of the corresponding color, to control apparatus 13. In the present disclosure, OEC 115 that can receive such visual light is referred to as second OEC 115b.

In the present disclosure, to facilitate the manufacture of image sensor 17, every pixel has the similar filter arrangement (see FIG. 4).

[2.1.3 Visual Fields]

See FIGS. 1 and 2 again. First visual field 21a to third visual field 21c of image sensor 17 will now be described in detail.

A purpose of back monitoring of vehicle V is to reduce accidents involving children or elderly people while vehicle V moves backward. Accordingly, as shown in FIG. 2, environment monitoring system 1 is required to achieve highly accurate detection of targets (e.g., children) at least in region of interest (hereinafter referred to as ROI) 23 just behind vehicle V without a detection error. As stated in “Background art”, pattern matching using visible images is not suitable for this use. As indicated by the dashed line in FIG. 2, ROI 23 is in a rectangular shape in a plan view from above and extends 6 m in the x-axis direction from the back end of vehicle V, and 1.5 m on the right and left sides in the y-axis direction from the longitudinal center line.

First visual field 21a will now be explained.

First visual field 21a has angle of view θ1v in bottom-top direction z (hereinafter referred to as vertical angle of view) and angle of view θ1h in the horizontal direction (hereinafter referred to as horizontal angle of view) in such a manner that it covers at least the back half of ROI 23, that is, a region remote from vehicle V.

Angle of view θ1v is, in a plan view from left-right direction y, a minor angle between optical axis A and line segment OP2 and is smaller than angle of view θ2v described later. Point P2 is a point on the road surface and d2 (m) away from point O in the x-axis direction. Here, d2 is d1<d2<6 (m), for example. The details of d1 will be described later.

Angle of view θ1h is smaller than angle of view θ2h described later in a plan view from bottom-top direction z.

Returning light from this first visual field 21a enters the light-receptive surface (described above) of first OEC 115a through an optical system (not shown in the drawing) including a lens.

In addition, image sensor 17 outputs, through the action of the peripheral circuitry not shown in the drawing, output signals from first OEC 115a to control apparatus 13 as invisible image signals (the details will be described later) related to first visual field 21a.

Second visual field 21b will now be explained.

For example, second visual field 21b contains first visual field 21a, is wider than first visual field 21a, and has vertical angle of view θ2v and horizontal angle of view θ2h.

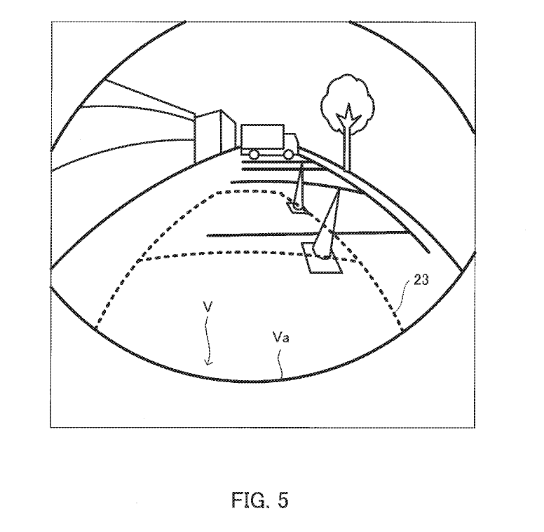

Vertical angle of view θ2v is a value that satisfies θ2v>>θ1v (e.g., a value close to 180°) and, as shown in FIG. 5, is selected such that second visual field 21b contains back end portion (e.g., bumper) Va of vehicle V. As horizontal angle of view θ2h, a value that satisfies θ2h>>θ1h (e.g., a value exceeding 180°) is selected.

Visual light from this second visual field 21b enters second OECs 115b through the aforementioned optical system (not shown in the drawing). Each second OEC 115b outputs a signal indicating the amount of light incident on it. In addition, image sensor 17 outputs, through the action of the peripheral circuitry, output signals from each second OEC 115b to control apparatus 13 as visible image signals described later.

Third visual field 21c will now be explained.

Third visual field 21c is, for example, next to first visual field 21a. In the present disclosure, third visual field 21c is defined directly below first visual field 21a and covers the front half of ROI 23 (i.e., a region that cannot be covered by first visual field 21a, that is, a region of ROI 23 adjacent to vehicle V) so that a combination of first visual field 21a and third visual field 21c can cover almost all the area of the aforementioned ROI 23.

Third visual field 21c is contained in second visual field 21b, is narrower than second visual field 21b, and has vertical angle of view θ3v and horizontal angle of view θ3h.

Angle of view θ3v is a minor angle between line segment OP2 and line segment OP1 in a plan view from left-right direction y, and is smaller than angle of view θ2v. Point P1 is a point on the road surface and d1 (m) away from point O in the x-axis direction. Here, d1 is expressed as 0<d1<d2.

Returning light from this third visual field 21c enters the light-receptive surface of third OEC 115c through the aforementioned optical system (not shown in the drawing). Each third OEC 115c outputs a signal indicating the amount of light incident on it to control apparatus 13. In addition, image sensor 17 outputs, through the action of the peripheral circuitry, output signals from each third OEC 115c to control apparatus 13 as invisible image signals (the details will be described later) related to third visual field 21c.

[2.1.4 Control Apparatus 13]

Control apparatus 13 is, for example, an ECU and includes an input terminal, an output terminal, a microprocessor, a program memory, and a main memory mounted on a control substrate in order to control back monitoring of vehicle V.

The microprocessor executes a program stored in the program memory by use of the main memory and processes various signals received through the input terminal while transmitting various control signals to light source 15 and image sensor 17 through the output terminal.

The aforementioned control apparatus 13 functions as control section 131, distance measurement section 133, contour extraction section 135, and target extraction section 137 as shown in FIG. 3 due to the execution of the program by the microprocessor. These function blocks 131 to 137 will now be described.

[2.1.5 Light Source Control and Image Sensor Light Reception Control Through Control Section 131]

Control section 131 outputs a control signal to light source 15 in order to control various conditions (e.g., pulse width, pulse amplitude, pulse interval and pulse number) of light emitted from light source 15.

Under the aforementioned light source control, for monitoring ROI 23, light source 15 emits visual light having power density Da toward first visual field 21a, which is a limited visual field, but does not emit invisible light toward third visual field 21c. This helps light emitted from light source 15, the output power of which is restrained by legal restraints and the like, travel as far as possible toward the back of vehicle (e.g., over 10 m from vehicle V).

In the present disclosure, the case in which Da>Dc (Dc=0) where Dc is the power density of light emitted toward third visual field 21c will be described as a preferred aspect. However, this is not necessarily the case and efficient use of output power of light source 15 can be obtained even when Da>Dc (Dc≠0).

Control section 131 also outputs control signals to the peripheral circuitry included in image sensor 17 in order to control various conditions (e.g., exposure time, exposure timing, and exposure count) related to light reception at image sensor 17. In the present disclosure, all OECs 115 are connected to common peripheral circuitry so that exposure time and exposure timing for each OEC 115 can be in synchronization.

Under the aforementioned exposure control and the like, image sensor 17 outputs invisible image signals and visible image signals to control apparatus 13 in a predetermined period (at a predetermined frame rate).

To be specific, invisible image signals are pulses output from plurality of first OECs 115a and plurality of third OECs 115c and contains pulses representing returning light for each pixel. Here, since third visual field 21c is a narrow visual field directly below and adjacent to first visual field 21a, if invisible light is emitted toward first visual field 21a, third OECs 115c can receive returning light reflected off objects in third visual field 21c.

Visible image signals are output from plurality of second OECs 115b and represent, in the present disclosure, concentrations related to objects in second visual field 21b by the intensities of red light, green light, and blue light. It should be noted that a visible image signal may be represented by a grayscale.

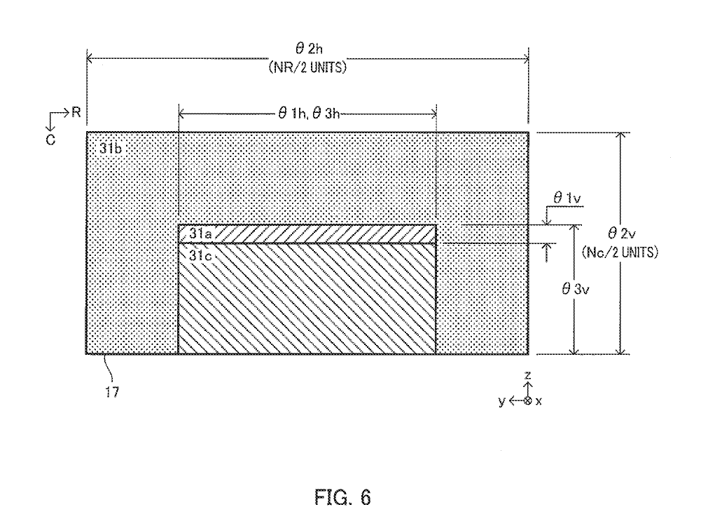

First visual field 21a to third visual field 21c have been described so far. According to such definition of visual fields, as shown in FIG. 6, a visible image can express an object in second visual field 21b through the entire pixel area 31b, while an invisible image can express a target possibly present in first visual field 21a and third visual field 21c through limited pixel areas: first pixel area 31a and third pixel area 31c.

In FIG. 6, for easy understanding of a correspondence relationship between first visual field 21a to third visual field 21c and the respective pixel areas 31a to 31c, the sizes of pixel areas 31a to 31c are shown by not only pixel counts but also angles.

FIG. 6 also shows front-rear direction x and the like of vehicle V in visible images and invisible images.

[2.1.6 Processing in Distance Measurement Section 133]

See FIGS. 1 to 3 again. Distance measurement section 133 derives the distance to target T in a visual field which is a combination of first visual field 21a and third visual field 21c (hereinafter referred to as composite visual field) by the time of flight method (hereinafter referred to as TOF method) in accordance with preferably an invisible image signal output from image sensor 17.

Distance Measurement by the TOF method will now be explained.

Measurement of the distance to target T by the TOF method is achieved by a combination of light source 15, plurality of first OECs 115a and third OECs 115c constituting image sensor 17, and distance measurement section 133.

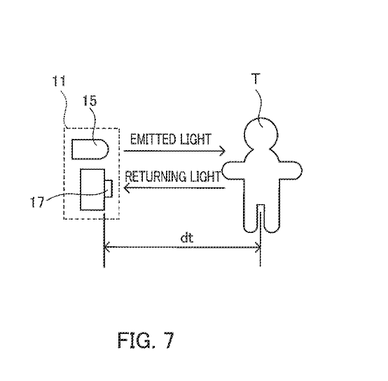

Distance measurement section 133 derives distance dt to target T shown in FIG. 7 by the TOF method in accordance with a time gap between an emission timing in light source 15 and a returning light-receiving timing in image sensor 17.

A more detailed example of distance measurement will now be explained.

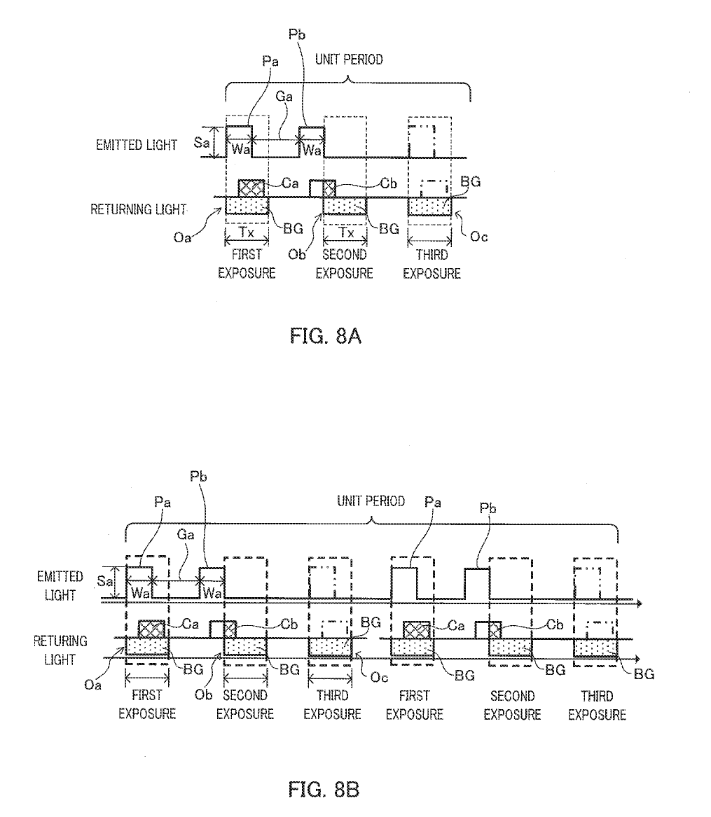

First, in some cases, control section 131 makes the number of pulses emitted from light source 15 in a predetermined period relatively small (hereinafter referred to as normal state) (see FIG. 8A).

In the normal state, as shown in FIG. 8A, light emitted from light source 15 includes at least a pair of first pulse Pa and second pulse Pb in a unit period. The pulse interval between them (i.e., the time from a falling edge of first pulse Pa to a rising edge of second pulse Pb) is represented by Ga. These pulse amplitudes are equal and represented by Sa, and these pulse widths are equal and represented by Wa.

Image sensor 17 is controlled by control section 131 in such a manner that it performs exposure in a timing according to the timing of when first pulse Pa and second pulse Pb are emitted. To give an example, as illustrated in FIG. 8A, image sensor 17 performs the first exposure, the second exposure, and the third exposure on returning light that is light emitted from light source 15 and reflected off target T in the composite visual field.

To be specific, the first exposure starts on the rising edge of first pulse Pa and ends after exposure time Tx that is predetermined according to light emitted from light source 15. An object of the first exposure is to receive returning light related to first pulse Pa.

Output Oa of first OEC 115a or the like obtained upon the first exposure contains returning light component Ca, which is diagonal-lattice hatched, and background component BG, which is dot hatched. The amplitude of returning light component Ca is smaller than that of first pulse Pa.

Here, the time difference between first pulse Pa and each rising edge of the corresponding returning light component Ca is represented by Δt. Here, Δt is the time that invisible light requires for travelling back and forth within space distance dt between imaging apparatus 11 and target T.

The second exposure, which is performed for reception of returning light related to second pulse Pb, starts on the falling edge of second pulse Pb and lasts for time Tx.

Output Ob of first OEC 115a or the like obtained upon the second exposure contains not all the returning light component but partial component Cb (see the diagonal-lattice hatched portions) and background component BG (see the dot hatched portions).

The aforementioned component Cb can be expressed by the following equation 1.

Cb=Ca×(At/Wa) (1)

The third exposure, which is performed to obtain only an invisible light component (background component) independent of the returning light component, starts in the timing not involving returning light component related to first pulse Pa or second pulse Pb and lasts only for time Tx.

Output signal (output level) Oc of first OEC 115a or the like obtained upon the third exposure contains only background component BG (see the dot hatched portions).

According to a relationship between this emitted light and returning light, distance dt from imaging apparatus 11 to target T can be derived from the following equations 2 to (4).

$$\begin{matrix} Ca = Oa - BG & ( 2 ) \\ Cb = Ob - BG & ( 3 ) \\ dt = c \times ( Δ t / 2 ) = \{ ( c \times Wa ) / 2 \} \times ( Δ t / Wa ) = \{ ( c \times Wa ) / 2 \} \times ( Cb / Ca ) & ( 4 )\end{matrix}$$

Here, c represents speed of light.

In the case where distance dt is derived in the above-described manner, if the intensity of returning light is low for each of first pulse Pa and second pulse Pb, the SNR of outputs Oa and Ob of first OEC 115a or the like becomes small, which may reduce the accuracy of derived distance dt.

For this reason, in the present disclosure, when the intensity of returning light is low, control section 131 controls light source 15 in such a manner that the number of emitted pulses increases. It should be noted that a known technique can be used for determination of whether the intensity of returning light is low, and the details will be omitted because it is not a major part of the present disclosure.

A method of deriving distance dt will now be explained with reference to FIG. 8B, taking the case where the number of emitted pulses per unit period is doubled from the normal state, as an example.

Light emitted from light source 15 has, per unit period, two pairs of first pulse Pa and second pulse Pb in the aforementioned conditions. Consequently, the frame rates of the invisible image signal and the visible image signal are lower than in the normal state.

Like in the normal state, image sensor 17 is controlled by control section 131 in such a manner that it performs exposure in a timing according to the timing of when first pulse Pa and second pulse Pb are emitted. In particular, for a pair of first pulse Pa and second pulse Pb, an exposure control operation consisting of the first exposure, the second exposure, and the third exposure is performed once.

Subsequently, returning light components Ca (see the equation 2) obtained by the respective exposure control operations are summed, and returning light partial components Cb (see the equation 3) obtained by the respective exposure control operations are summed. It should be noted that these summing operations contribute to a reduction in white noise.

Afterwards, the total value of returning light component Ca and the total value of partial component Cb are substituted in the equation 4, thereby deriving distance dt. Since white noise is reduced as described above, the influence of white noise on the accuracy of derived distance dt can be suppressed.

For example, distance measurement section 133 derives distance dt per pixel unit per unit period, thereby generating distance image data in the composite visual field.

[2.1.7 Contour Extraction Section 135]

Contour extraction section 135 receives a visible image signal from plurality of second OEC 115b per unit period, extracts the contour of the object in second visual field 21b in accordance with the received visible image signal, and generates contour information for defining the extracted contour.

[2.1.8 Target Extraction Section 137]

For example, target extraction section 137 acquires distance image data from distance measurement section 133 per unit period and acquires contour information from contour extraction section 135.

Target extraction section 137 extracts, from the received distance image data, a section representing the target present in the composite visual field, as the first target information.

Target extraction section 137 also extracts a section representing the target present in second visual field 21b from the current contour information and the previous contour information acquired from contour extraction section 135 by, for example, the optical flow estimation, as the second target information.

Target extraction section 137 grants a target ID to the extracted first target information and/or second target information so that the detected target can be uniquely identified.

Here, after a lapse of time, the same target from outside of the composite visual field (second visual field 21b) enters the composite visual field (a combination of first visual field 21a and third visual field 21c) in some cases. On the contrary, the same target goes out of the composite visual field into the outside of the composite visual field in some cases.

For a target entering the composite visual field, upon detection of its entry to the composite visual field, target extraction section 137 replaces the second target information representing one target with the first target information representing the same target.

On the contrary, for a target going out of the composite visual field, upon its occurrence, target extraction section 137 replaces the first target information representing one target with the second target information representing the same target. At this time, in the optical flow estimation, which yields a larger measurement error than the time of flight method, the second target information to be replaced is preferably selected taking a measurement error into consideration.

[2.1.9 Output of Environment Monitoring System 1]

Environment monitoring system 1 transmits the combination of the first target information and a target ID, the combination of the second target information and a target ID, distance image data, and the invisible image signal and the visible image signal to an ADAS ECU which is not shown in the drawing. The ADAS ECU performs automated driving of vehicle V by using these information and signals.

In addition, control section 131 may generate image data to be presented on a display not shown in the drawing, in accordance with the combination of the first target information and a target ID, the combination of the second target information and a target ID, distance image data, and the invisible image signal and the visible image signal.

[2.2 Effects of Environment Monitoring System 1]

Regarding environment monitoring system 1 of the present disclosure, the power density and the like of the output of light source 15 are restrained by law, for example. For this reason, regarding this environment monitoring system 1, if first visual field 21a is widen, the distance measurable by distance measurement section 133 is shorten.

Meanwhile, if ROI 23 is defined depending on the purpose as in this environment monitoring system 1, first visual field 21a can be made limitative compared with second visual field 21b. Accordingly, second visual field 21b is contained in first visual field 21a and narrower than first visual field 21a. Consequently, light source 15 can emit invisible light intensively into first visual field 21a, thereby allowing light emitted from light source 15 to travel further in first visual field 21a. Thus, the distance measurable by distance measurement section 133 by the TOF method can be made longer.

In addition, regarding this environment monitoring system 1, third visual field 21c is defined directly below first visual field 21a to cover ROI 23 together with first visual field 21a. Preferably, invisible light is not emitted from light source 15 into this third visual field 21c. In other words, Da>Dc (Dc=0) where Da is the power density of light emitted toward first visual field 21a and Dc is the power density of light emitted toward third visual field 21c. Distance measurement section 133 performs distance measurement also dependent on such an output signal from third OEC 115c. Accordingly, second visual field 21b can be made more limitative, so that the distance measurable by distance measurement section 133 can be further made longer.

[3. Note]

The entire configuration of environment monitoring system 1 has been described above. However, the scope of the present disclosure is directed not only at environment monitoring system 1 but also imaging apparatus 11 that can be independently distributed to the market.

[3.1 First Alternative to Arrangement of OECs]

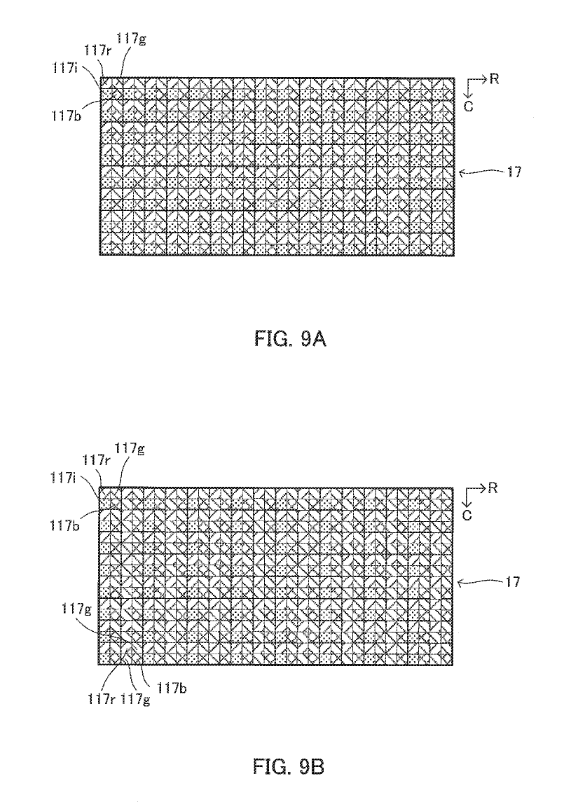

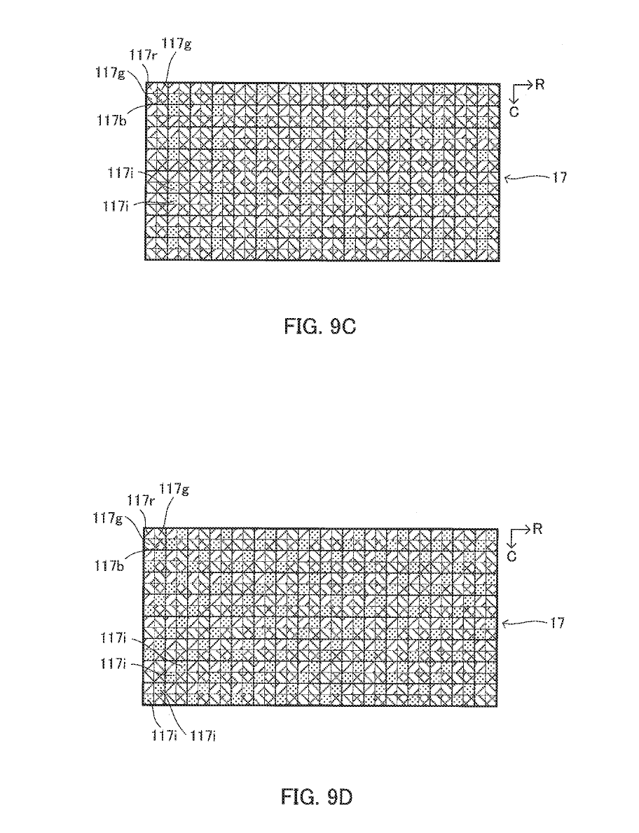

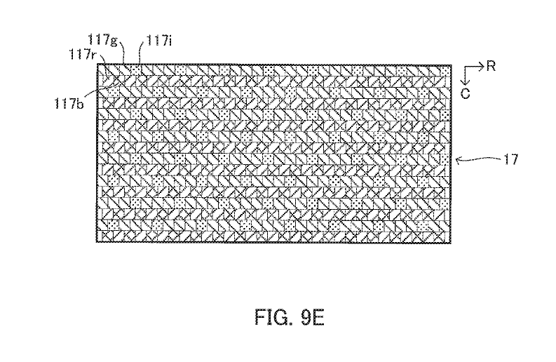

In the present disclosure, the description has been made on the assumption that every pixel in image sensor 17 has the same filter arrangement as shown in FIG. 9A. In FIG. 9A, which shows only filter arrangement for one pixel as a representative example, the slash hatched area represents red filter 117r, the backslash hatched area represents green filter 117g, the lattice hatched area represents blue filter 117b, and the dot hatched area represents IR filter 117i. The same applies to FIGS. 9B to 9D.

However, this is not necessarily the case and, as in the present disclosure, if the object of environment monitoring system 1 is back monitoring, the resolution in the vertical direction (bottom-top direction z) is more important than the resolution in the horizontal direction (left-right direction y).

Accordingly, as shown in FIG. 9B, the number of IR filters 117i in column direction C per unit length may be larger than that in row direction R.

[3.2 Second Alternative to Arrangement of OECs]

Alternatively, as shown in FIG. 9C, two consecutive OECs 115 in column direction R may be independently covered by IR filter 117i. Output signals from these two OECs 115 (i.e., first OEC 115a and third OEC 115c) can be regarded as being based on light returning from the same object; therefore, distance measurement section 133 may perform distance measurement by the TOF method in accordance with the addition results of output signals from two adjacent first OECs 115a. Hence, addition results with a favorable SNR are used and the accuracy of distance measurement can be improved.

[3.2 Third Alternative to Arrangement of OECs]

Alternatively, as shown in FIG. 9D, two consecutive OECs 115 in a diagonal direction may be independently covered by IR filter 117i.

[3.3 Fourth Alternative to Arrangement of OECs]

Alternatively, as shown in FIG. 9E, to increase the apparent resolution of the visible image signal, the number of green filters 117g may be 1.5 times the number of red filters 117r and the number of IR filters 117i may be 0.5 times the number of red filters 117r.

### INDUSTRIAL APPLICABILITY

An environment monitoring system and an imaging apparatus related to the present disclosure can provide longer measurable distance and are suitable for use in a car.

### REFERENCE SIGNS LIST

1 Environment monitoring system
11 Imaging apparatus
15 Light source
17 Image sensor
115a First optical/electrical converter
115b Second optical/electrical converter
115c Third optical/electrical converter
13 Control apparatus

1. An environment monitoring system mountable on a vehicle, comprising:
a light source that emits invisible light;
a plurality of first optical/electrical converters output a signal upon reception of invisible light emitted from the light source and reflected off a target in a first visual field that is a part of visual field in surroundings of the vehicle, the signal indicating an amount of incident light;
a plurality of second optical/electrical converters that constitute an optical/electrical converter array together with the plurality of first optical/electrical converters and output a signal upon reception of visual light from a second visual field containing the first visual field, the signal indicating an amount of incident light; and
a control apparatus that derives a distance to the target in accordance with output signals from the plurality of first optical/electrical converters, wherein
the light source emits invisible light toward the first visual field.

2. The environment monitoring system according to claim 1, wherein the control apparatus derives the distance by the time of flight method.

3. The environment monitoring system according to claim 1, further comprising:
a plurality of third optical/electrical converters that output a signal upon reception of invisible light reflected off a target in a third visual field adjacent to the first visual field, the signal indicating an amount of incident light, wherein
the control apparatus detects a target present in the first visual field and the third visual field in accordance with output signals from the plurality of third optical/electrical converters in addition to the output signals from the plurality of first optical/electrical converters.

4. The environment monitoring system according to claim 3, wherein the third visual field is closer to the vehicle than the first visual field.

5. The environment monitoring system according to claim 3, wherein the light source does not emit invisible light toward the third visual field or power density of invisible light emitted toward the first visual field is larger than power density of invisible light emitted toward the third visual field.

6. The environment monitoring system according to claim 1, wherein the control apparatus further detects a target present in the second visual field in accordance with output signals from the plurality of second optical/electrical converters.

7. An imaging apparatus mountable on a vehicle, comprising:
a light source that emits invisible light;
a plurality of first optical/electrical converters that output a signal upon reception of invisible light emitted from the light source and reflected off a target in a first visual field that is a part of visual field in surroundings of the vehicle, the signal indicating an amount of incident light; and
a plurality of second optical/electrical converters that constitute an optical/electrical converter array together with the plurality of first optical/electrical converters and output a signal upon reception of visual light from a second visual field containing the first visual field, the signal indicating an amount of incident light, wherein
the light source emits invisible light toward the first visual field.
